(19) United States
(12) Patent Application Publication
(10) Pub. No.: US 2025/0264756 A1
(43) Pub. Date: Aug. 21, 2025

(54) REFLECTIVE DISPLAY PANEL AND SPUTTERING TARGET

(71) Applicant: HannStar Display Corporation, Taipei City (TW)

(72) Inventors: Yu-Chi Chiao, Taipei City (TW); I-Tung Chen, Taipei City (TW); Chiung-Chang Wu, Taipei City (TW); Hsien-Tang Hu, Taipei City (TW); Chao-Hsien Wang, Taipei City (TW); Chun Chieh Wang, Taipei City (TW)

(73) Assignee: HannStar Display Corporation, Taipei City (TW)

(21) Appl. No.: 18/945,532

(22) Filed: Nov. 13, 2024

Related U.S. Application Data
(60) Provisional application No. 63/555,105, filed on Feb. 19, 2024.

(30) Foreign Application Priority Data
Apr. 16, 2024 (TW) 113114199

(51) Int. Cl. G02F 1/1335; G02F 1/1333

(52) U.S. Cl. CPC G02F 1/133553; G02F 1/133311; G02F 1/133345; G02F 2201/50; G02F 2203/02

(57) ABSTRACT

A reflective display panel having a pixel structure is provided. The pixel structure has a reflective area, and includes an active device, an insulation layer and a reflective layer. The insulation layer is disposed above the active device. The reflective layer is disposed on the insulation layer and located in the reflective area. The reflective layer includes a silver alloy layer. The material of the silver alloy layer includes silver with a weight percentage greater than 90% and indium with a weight percentage greater than or equal to 2% and less than or equal to 8%. A sputtering target suitable for depositing the silver alloy layer is also provided.

### CROSS-REFERENCE TO RELATED APPLICATION

This application claims the priority benefit of U.S. provisional application Ser. No. 63/555,105, filed on Feb. 19, 2024 and Taiwan application serial no. 113114199, filed on Apr. 16, 2024. The entirety of each of the above-mentioned patent applications is hereby incorporated by reference herein and made a part of this specification.

### BACKGROUND

### Technical Field

The disclosure relates to a display panel and process materials, and in particular relates to a reflective display panel and a sputtering target.

### Description of Related Art

A reflective display panel mainly utilizes natural light or ambient light as a light source for display. Therefore, it is often used outdoors or in areas with sufficient light, such as outdoor billboards, electronic tags, sports watches, etc. Considering high reflectivity and low resistivity, silver is the first choice among all metallic elements as a reflective layer. However, due to the poor chemical resistance, heat resistance, and weather resistance of the silver element, along with its high electrochemical mobility, there are many problems and limitations in the application of silver.

### SUMMARY

A reflective display panel, the reflective layer of which has better optical stability and durability, and has a higher reflectivity, is provided in the disclosure.

A sputtering target, the deposited film layer of which has better heat resistance and chemical resistance, and also provides a more effective resistance to grain agglomeration, is provided in the disclosure.

The reflective display panel of the disclosure has a pixel structure. The pixel structure has a reflective area and includes an active device, an insulation layer and a reflective layer. An insulation layer is disposed above the active device. The reflective layer is disposed on the insulation layer and located in the reflective area. The reflective layer includes a silver alloy layer. The material of the silver alloy layer includes silver with a weight percentage greater than 90% and indium with a weight percentage greater than or equal to 2% and less than or equal to 8%.

In an embodiment of the disclosure, the material of the silver alloy layer of the reflective display panel further includes at least one of antimony and palladium.

In an embodiment of the disclosure, the material of the silver alloy layer of the reflective display panel further includes antimony with a weight percentage of less than or equal to 3%.

In an embodiment of the disclosure, the material of the silver alloy layer of the reflective display panel further includes palladium with a weight percentage of less than or equal to 3%. In an embodiment of the disclosure, the reflective layer of the reflective display panel

further includes a protective layer covering the silver alloy layer. The material of the protective layer includes a light-transmissive conductive material or a light-transmissive insulation material.

In an embodiment of the disclosure, the material of the protective layer of the reflective display panel is selected from at least one of an oxide, a nitride, and an oxynitride.

In an embodiment of the disclosure, the silver alloy layer and the protective layer of the reflective display panel are formed by continuous deposition in the same process equipment.

In an embodiment of the disclosure, the reflective layer of the reflective display panel further includes a buffer layer disposed between the insulation layer and the silver alloy layer, and the material of the buffer layer includes a conductive material.

In an embodiment of the disclosure, a thickness of the silver alloy layer of the reflective display panel is 70 nanometers to 200 nanometers.

In an embodiment of the disclosure, the reflective display panel is a fully reflective display panel or a transflective display panel.

The sputtering target of the disclosure is suitable for depositing the silver alloy layer. The material of the sputtering target includes silver with a weight percentage greater than 90% and indium with a weight percentage greater than or equal to 2% and less than or equal to 8%.

Based on the above, in the reflective display panel according to an embodiment of the disclosure, for the material of the sputtering target used to deposit the reflective layer, in addition to including silver with a weight percentage of more than 90%, the material also includes indium with a weight percentage greater than or equal to 2% and less than or equal to 8%. Therefore, the chemical resistance and heat resistance of the silver alloy layer deposited using the sputtering target may be significantly improved, thereby increasing the optical stability and durability of the reflective layer. In addition, the above-mentioned silver alloy layer may also have smaller surface roughness, which facilitates in maintaining the high reflectivity of the silver alloy material.

### BRIEF DESCRIPTION OF THE DRAWINGS

FIG. 1 is a cross-sectional schematic diagram of a reflective display panel according to a first embodiment of the disclosure.

FIG. 2 is a cross-sectional schematic diagram of the pixel structure of the reflective display panel according to the first embodiment of the disclosure.

FIG. 3A is an enlarged cross-sectional diagram of the reflective layer of FIG. 2.

FIG. 3B is an enlarged cross-sectional diagram of another modified embodiment of the reflective layer of FIG. 2.

FIG. 4 is a partial flow chart of a manufacturing method of a reflective display panel according to the first embodiment of the disclosure.

FIG. 5A to FIG. 5D are schematic diagrams of the manufacturing method of FIG. 4.

FIG. 6A to FIG. 6D are schematic diagrams of forming a buffer material layer, a silver alloy material layer and a protective material layer in a reflective material layer in the same process equipment according to the first embodiment of the disclosure.

FIG. 7 is an enlarged cross-sectional diagram of the reflective layer of the reflective display panel according to a second embodiment of the disclosure.

FIG. 8 is a partial flow chart of a manufacturing method of a reflective display panel having the reflective layer of FIG. 7.

FIG. 9A to FIG. 9C are schematic diagrams of the manufacturing method of FIG. 8.

FIG. 10 is a cross-sectional schematic diagram of a reflective display panel according to a third embodiment of the disclosure.

FIG. 11 is a cross-sectional schematic diagram of the pixel structure of the reflective display panel according to the third embodiment of the disclosure.

FIG. 12 is a cross-sectional schematic diagram of the pixel structure of the reflective display panel according to a fourth embodiment of the disclosure.

### DETAILED DESCRIPTION OF DISCLOSED EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

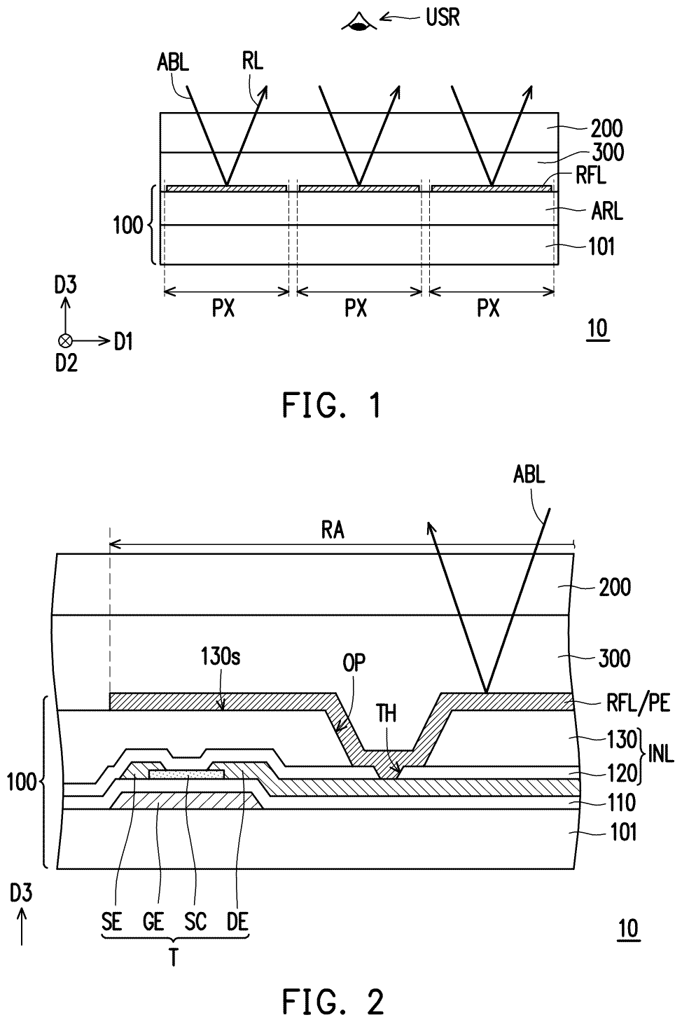

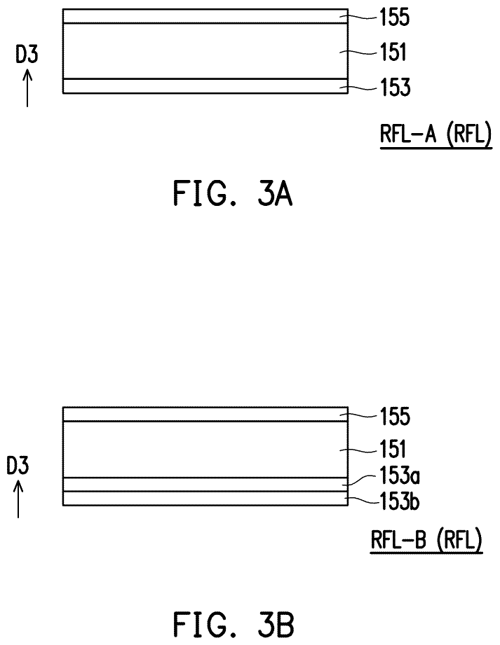

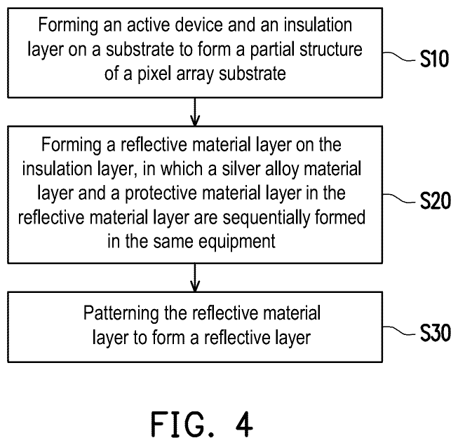

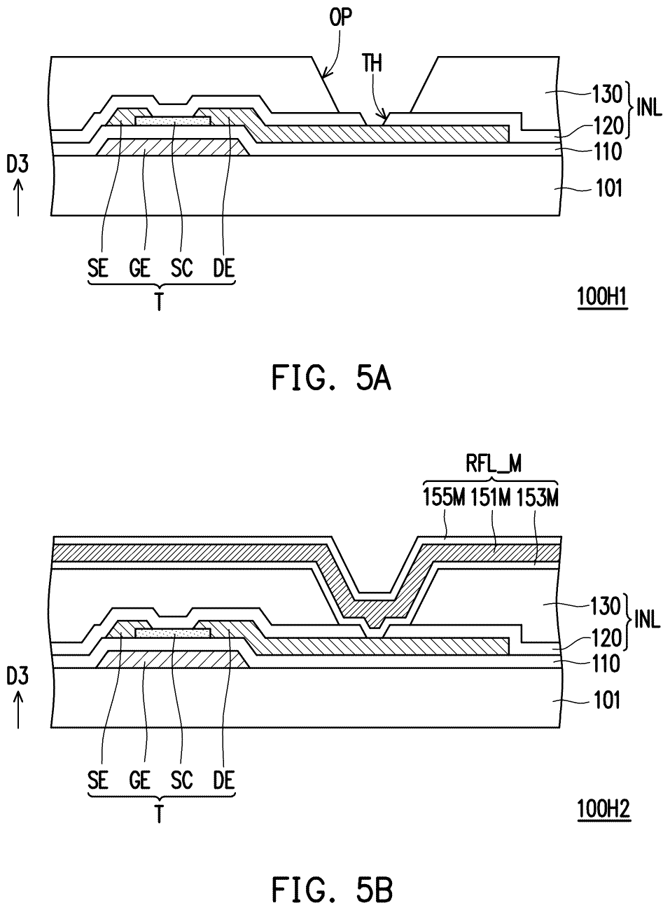

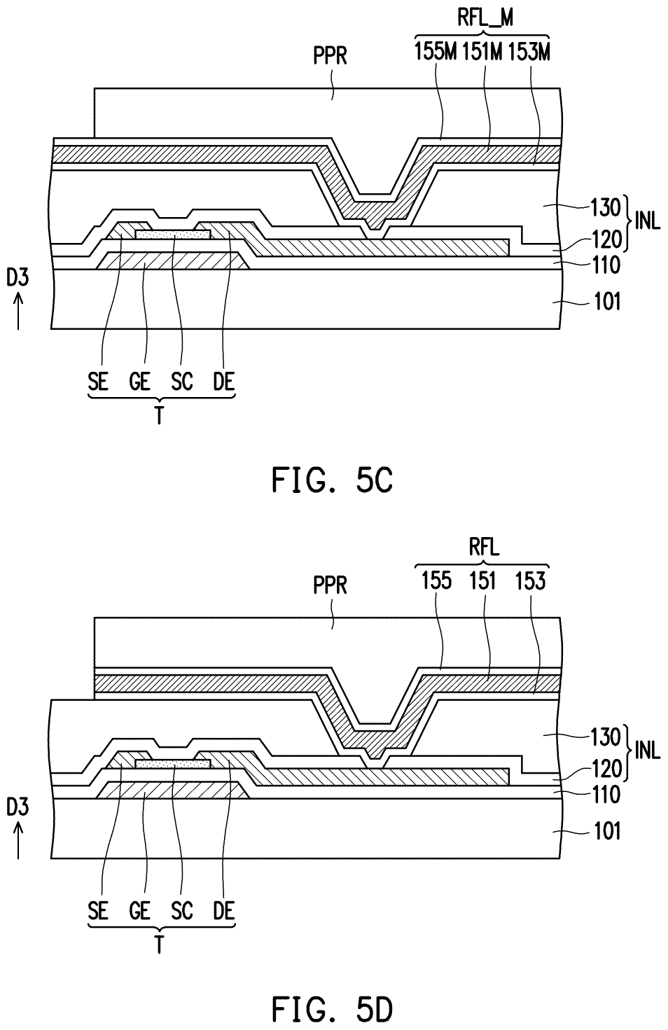

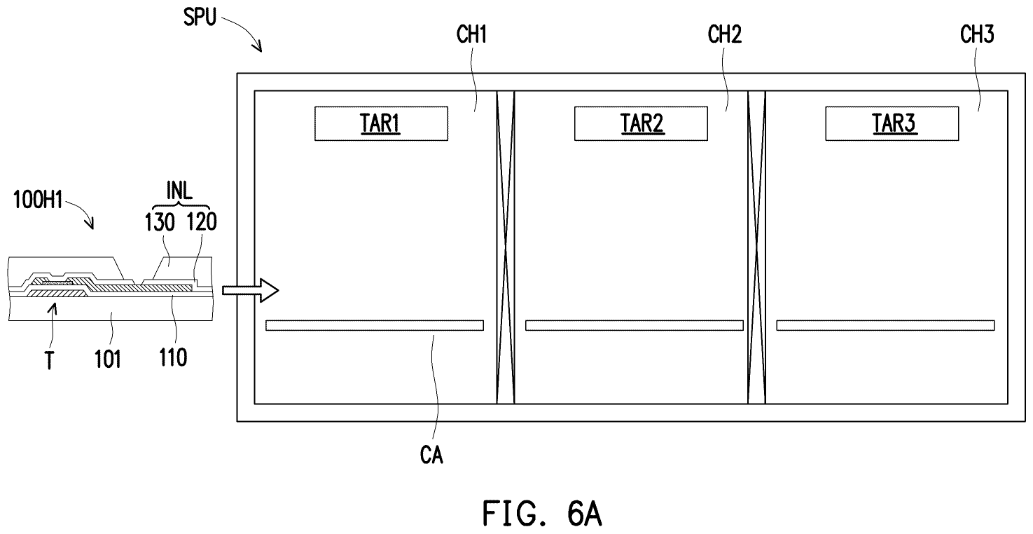

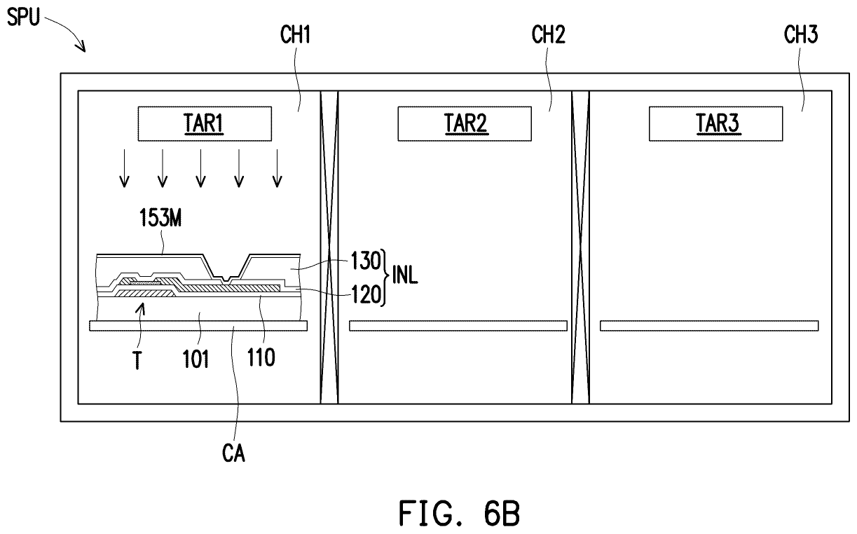

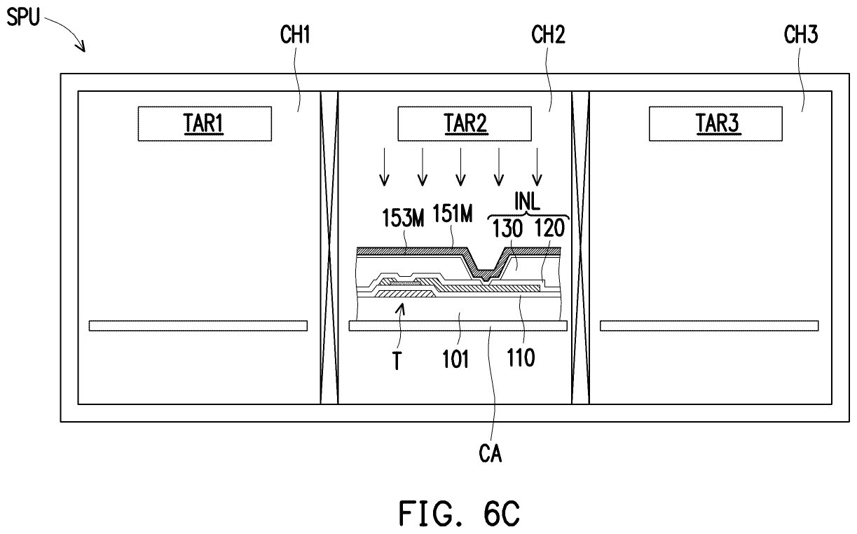

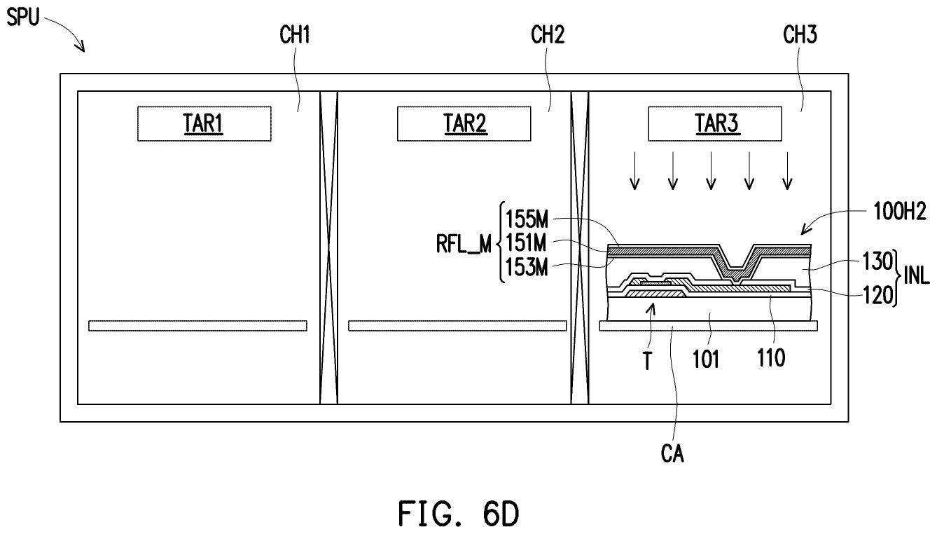

FIG. 1 is a cross-sectional schematic diagram of a reflective display panel according to a first embodiment of the disclosure. FIG. 2 is a cross-sectional schematic diagram of the pixel structure of the reflective display panel according to the first embodiment of the disclosure. FIG. 3A is an enlarged cross-sectional diagram of the reflective layer of FIG. 2. FIG. 3B is an enlarged cross-sectional diagram of another modified embodiment of the reflective layer of FIG. 2. FIG. 4 is a partial flow chart of a manufacturing method of a reflective display panel according to the first embodiment of the disclosure. FIG. 5A to FIG. 5D are schematic diagrams of the manufacturing method of FIG. 4. FIG. 6A to FIG. 6D are schematic diagrams of forming a buffer material layer, a silver alloy material layer and a protective material layer in a reflective material layer in the same process equipment according to the first embodiment of the disclosure.

Referring to FIG. 1, a reflective display panel 10 includes a pixel array substrate 100. In this embodiment, the pixel array substrate 100 may include a substrate 101 and multiple pixel structures PX. Although FIG. 1 only shows multiple pixel structures PX arranged along the first direction D1 of the pixel array substrate 100, it may be understood that multiple pixel structures PX may be arranged in an array on the substrate 101, for example: these pixel structures PX may be arranged in multiple columns and rows along two mutually perpendicular directions (e.g., the first direction D1 and the second direction D2). The material of the substrate 101 may include glass, quartz, high molecular polymer (e.g., polyimide, polycarbonate, poly(methyl methacrylate), or other suitable flexible plate materials), or other suitable plate materials.

Referring to FIG. 1 and FIG. 2, the pixel array layer ARL is disposed on the substrate 101, and the reflective layer RFL is disposed on the pixel array layer ARL. The pixel array layer ARL includes an active device and an insulation layer (e.g., the active device T and the insulation layer INL in FIG. 2), and the material of the reflective layer RFL includes a metal with high reflectivity, such as a metal alloy including silver. The incident light ABL is reflected by the reflective layer RFL to be a reflected light RL to form a corresponding display image in the eyes of the user USR.

In this embodiment, the incident light ABL may be ambient light, light from a front light module, or a combination thereof. In this embodiment, the pixel array substrate 100 includes a substrate 101, a pixel array layer ARL, and multiple reflective layers RFL. In addition, in some embodiments, the pixel array substrate 100 may also include an alignment layer (not shown), which is disposed on the pixel array layer ARL and the reflective layers RFL, and the alignment layer is configured to align multiple liquid crystal molecules (not shown) in the liquid crystal layer (i.e., the display medium layer 300). The material of the alignment layer may include polyimide or other suitable materials.

In this embodiment, the method of forming the active device T may include the following steps: sequentially forming a gate electrode GE, a gate insulation layer 110, a semiconductor pattern SC, a source electrode SE, and a drain electrode DE on the substrate 101. The semiconductor pattern SC is arranged to overlap the gate electrode GE. The source electrode SE and the drain electrode DE overlap the semiconductor pattern SC and are in electrical contact with two different regions of the semiconductor pattern SC. In this embodiment, the gate electrode GE of the active device T may be selectively disposed under the semiconductor pattern SC to form a bottom-gate thin film transistor (bottom-gate TFT), but not limited thereto. In other embodiments, the gate electrode of the active device may be selectively disposed above the semiconductor pattern to form a top-gate thin film transistor (top-gate TFT).

It should be noted that the gate electrode GE, the source electrode SE, the drain electrode DE, the semiconductor pattern SC, and the gate insulation layer 110 may be respectively implemented by any gate electrode, any source electrode, any drain electrode, any semiconductor pattern, and any gate insulation layer known to those skilled in the art for reflective display panels. The gate electrode GE, the source electrode SE, the drain electrode DE, the semiconductor pattern SC, and the gate insulation layer 110 may be formed by any method well known to those skilled in the art, and therefore will not repeated be herein.

Furthermore, the reflective display panel 10 further includes an insulation layer INL. In this embodiment, the insulation layer INL includes a passivation layer 120 and a planarization layer 130, but not limited thereto. In some embodiments, the insulation layer INL may be a single-layer structure and only include the passivation layer 120 or the planarization layer 130. The passivation layer 120 covers multiple active devices T of the pixel structures PX. The planarization layer 130 covers the passivation layer 120. In this embodiment, the material of the planarization layer 130 may be an organic material, and the material of the passivation layer 120 may be an inorganic material, but not limited thereto. The passivation layer 120 is located between the planarization layer 130 and the metal layer (e.g., the source electrode SE and the drain electrode DE of the active device T) to prevent the planarization layer 130 and the metal layer from peeling off due to poor adhesion, but not limited thereto. The pixel electrode PE of the pixel structure PX is disposed on the surface 130s of the planarization layer 130 facing away from the substrate 101, and is electrically connected to the drain electrode DE of the active device T through the opening OP of the planarization layer 130 and the contact hole TH of the passivation layer 120.

For example, the reflective display panel 10 may further include another substrate 200 and a display medium layer 300, in which the display medium layer 300 is disposed between the pixel array substrate 100 and the substrate 200. In this embodiment, the display medium layer 300 is, for example, a liquid crystal layer. That is, the reflective display panel 10 of this embodiment may be a reflective liquid crystal display panel, but not limited thereto.

On the other hand, a color filter layer (not shown) and/or a common electrode layer (not shown) may be disposed on the substrate 200, but not limited thereto. In some embodiments, the common electrode layer may be disposed in the pixel array substrate 100. The electric field generated between the common electrode layer and the pixel electrode PE is suitable to drive multiple liquid crystal molecules (not shown) in the liquid crystal layer (i.e., the display medium layer 300) to rotate to form an arrangement state corresponding to the direction and intensity of the electric field. By changing the arrangement state of these liquid crystal molecules, the polarization states of the incident light ABL and the reflected light RL passing through the liquid crystal layer are changed to form a light emission brightness corresponding to the arrangement state. In addition, in some embodiments, the reflective display panel 10 may further include another alignment layer (not shown), which is disposed on the surface of the substrate 200 facing the display medium layer 300, and the another alignment layer is configured to align multiple liquid crystal molecules (not shown) in the liquid crystal layer (i.e., the display medium layer 300).

In this embodiment, the pixel electrode PE is, for example, a reflective electrode made of a metal alloy material including silver. That is, the pixel electrode PE of this embodiment also serves as the reflective layer RFL of the reflective display panel 10, and the reflective layer RFL includes a silver alloy layer. Therefore, in this embodiment, the pixel structure PX includes an active device T, an insulation layer INL and a reflective layer RFL, and the reflective layer RFL is located in the reflective area RA of the pixel structure PX. It should be noted that the reflective display panel 10 in this embodiment may be a fully reflective display panel in which the pixel structure has only a reflective area RA, or a transflective display panel in which the pixel structure has a reflective area RA and a transmissive area (not shown).

Referring to FIG. 2 and FIG. 3A, the reflective layer RFL-A includes a silver alloy layer 151. In this embodiment, the thickness of the silver alloy layer 151 may be 70 nanometers (nm) to 200 nanometers, and is preferably 90 nanometers to 100 nanometers, so that the grains are smaller and the roughness is reduced, thereby improving the reflectivity of the silver alloy layer 151, but not limited thereto. In order to improve the adhesion between the silver alloy layer 151 and the insulation layer INL, the reflective layer RFL may also selectively include a buffer layer 153 disposed between the planarization layer 130 and the silver alloy layer 151. The buffer layer 153 may be a conductive layer. In this embodiment, the material of the buffer layer 153 may be a light-transmissive or opaque conductive material. For example, the material of the buffer layer 153 includes ITO, IZO, Mo, MoOₓ, MoTa, AlNd or Ti. However, the disclosure is not limited thereto. In another modified embodiment, the number of buffer layers of the reflective layer RFL may also be multiple (e.g., the buffer layer 153a and the buffer layer 153b in the reflective layer RFL-B in FIG. 3B), that is, the buffer layer of the reflective layer RFL may be a stacked structure of multiple buffer layers, in which the materials of the multiple buffer layers may be different.

On the other hand, in order to prevent the silver alloy layer 151 from being exposed to the air for a long time, causing material deterioration (e.g., the silver alloy layer 151 is sulfurized and/or oxidized) and affecting the optical properties (e.g., the color of the silver alloy layer 151 changes and/or or the reflectivity decreases), the reflective layer RFL may also selectively include a protective layer 155 covering the silver alloy layer 151. The material of the protective layer 155 may include a light-transmissive conductive material or a light-transmissive insulation material, so that at least a part of the incident light ABL may pass through the protective layer 155 to reach the silver alloy layer 151, and the light reflected by the silver alloy layer 151 may pass through the protective layer 155 to form at least a part of the reflected light RL. The protective layer 155 may be a conductive layer or a non-conductive layer, and is a film layer with high transmittance. For example, the material of the protective layer 155 may include at least one of oxide, nitride and oxynitride, such as ITO, IZO, SiO₂, SiNₓ, SiOₓN_{y} or Al₂O₃.

Referring to FIG. 4, a part of the manufacturing method of the reflective display panel 10 includes steps S10 to S30. Referring to FIG. 4 and FIG. 5A, step S10 includes forming an active device T and an insulation layer INL on the substrate 101 to form a partial structure 100H1 of the pixel array substrate. The planarization layer 130 has an opening OP, and the passivation layer 120 has a contact hole TH. Referring to FIG. 4 and FIG. 5B, step S20 is performed next. Step S20 includes forming a reflective material layer RFL_M on the insulation layer INL to form a partial structure 100H2 of the pixel array substrate. The reflective material layer RFL_M includes a buffer material layer 153M, a silver alloy material layer 151M and a protective material layer 155M. The silver alloy material layer 151M and the protective material layer 155M in the reflective material layer RFL_M are sequentially formed in the same process equipment. In this embodiment, the silver alloy material layer 151M and the protective material layer 155M in the reflective material layer RFL_M are formed by continuous deposition in the same process equipment (such as sputtering equipment). That is, after the silver alloy material layer 151M is formed, a protective material layer 155M for protecting the silver alloy material layer 151M may be formed on the silver alloy material layer 151M without moving the substrate with the silver alloy material layer 151M out of the process equipment, thus preventing the silver alloy material layer 151M from being exposed to the air and being sulfurized and/or oxidized. In this embodiment, the buffer material layer 153M and the silver alloy material layer 151M in the reflective material layer RFL_M may be sequentially formed in the same process equipment, or respectively formed in two process equipment.

For example, as shown in FIG. 6A to FIG. 6D, the partial structure 100H1 of the pixel array substrate in FIG. 5A may be transferred to the sputtering equipment SPU to form the reflective material layer RFL_M. The reflective material layer RFL_M includes a buffer material layer 153M, a silver alloy material layer 151M and a protective material layer 155M. The materials of the buffer material layer 153M, the silver alloy material layer 151M and the protective material layer 155M may be, for example, ITO, silver alloy and ITO respectively. The sputtering equipment SPU includes three sputtering chambers CH1, CH2, and CH3, and the sputtering chambers CH1, CH2, and CH3 are respectively used to sputter to form the buffer material layer 153M, the silver alloy material layer 151M, and the protective material layer 155M. The partial structure 100H1 of the pixel array substrate in FIG. 5A is transferred to the chamber CHI in the sputtering equipment SPU (as shown in FIG. 6A). The partial structure 100H1 of the pixel array substrate is located on the carrier CA, the ITO target TAR1 is disposed in the chamber CH1, and a sputtering process is used to form a buffer material layer 153M on the insulation layer INL (as shown in FIG. 6B). Next, the partial structure of the pixel array substrate in FIG. 6B is transferred to the chamber CH2 in the sputtering equipment SPU, the silver alloy target TAR2 is disposed in the chamber CH2, and a sputtering process is used to form a silver alloy material layer 151M on the buffer material layer 153M (as shown in FIG. 6C). Next, the partial structure of the pixel array substrate in FIG. 6C is transferred to the chamber CH3 in the sputtering equipment SPU, the ITO target TAR3 is disposed in the chamber CH3, and a sputtering process is used to form a protective material layer 155M on the silver alloy material layer 151M (as shown in FIG. 6D) to form the partial structure 100H2 of the pixel array substrate in FIG. 5B. Next, the partial structure 100H2 of the pixel array substrate is moved out from the sputtering equipment SPU (not shown). The sputtering equipment SPU shown in FIG. 6A to FIG. 6D is only an example, and this embodiment does not limit the form of the process equipment used for continuous deposition. For example, the sputtering equipment may have one chamber, and the partial structure 100H1 of the pixel array substrate in FIG. 5A is transferred to the chamber of the sputtering equipment. The ITO target TAR1, silver alloy target TAR2, and ITO target TAR3 may be sequentially transferred into the chamber to sequentially form a buffer material layer 153M, a silver alloy material layer 151M, and a protective material layer 155M on the insulation layer INL, likewise preventing the silver alloy material layer 151M from being exposed to the air and being sulfurized and/or oxidized.

Referring to FIG. 4, FIG. 5C and FIG. 5D, step S30 is performed next. Step S30 includes patterning the reflective material layer RFL_M in the structure of FIG. 5B to form a reflective layer RFL. For example, a patterned photoresist layer PPR may be formed on the reflective material layer RFL_M (as shown in FIG. 5C), and the reflective material layer RFL_M is patterned through an etching process to form the reflective layer RFL (as shown in FIG. 5D). The buffer material layer 153M, the silver alloy material layer 151M and the protective material layer 155M in the reflective material layer RFL_M are respectively patterned to form the buffer layer 153, the silver alloy layer 151 and the protective layer 155 in the reflective layer RFL. Therefore, the materials of the buffer material layer 153M, the silver alloy material layer 151M and the protective material layer 155M are the same as the materials of the buffer layer 153, the silver alloy layer 151 and the protective layer 155 respectively.

In particular, although the protective material layer 155M and the silver alloy material layer 151M are manufactured in the same process equipment, in order to avoid the phenomenon that the silver element in the silver alloy material layer 151M formed before the protective material layer 155M is condensed due to thermal diffusion during the film formation process of the protective material layer 155M, resulting in a decrease in reflectivity, the material of the sputtering target used for depositing the silver alloy layer 151 (i.e., the sputtering target for depositing the silver alloy material layer 151M, such as the silver alloy target TAR2 in FIG. 6C) includes not only silver with a weight percentage greater than 90%, but also indium with a weight percentage greater than or equal to 2% and less than or equal to 8%. Since the addition of indium may improve the heat and sulfur resistance of the silver alloy material layer 151M and silver alloy layer 151, and may reduce the roughness of the silver alloy material layer 151M and silver alloy layer 151, therefore, by adding indium with a weight percentage greater than or equal to 2% and less than or equal to 8%, it may be ensured that the reflective surface of the silver alloy material layer 151M maintains a smaller surface roughness and a better reflectivity after the film formation process of the protective material layer 155M. Moreover, it effectively improves the thermal resistance and chemical resistance of the silver alloy material layer 151M and the silver alloy layer 151.

In this embodiment, the sputtering target used to deposit the silver alloy layer 151 may further include at least one of antimony with a weight percentage less than or equal to 3% and palladium with a weight percentage less than or equal to 3%.

Since the addition of antimony not only improves the heat resistance and chlorine resistance of the silver alloy material layer 151M and silver alloy layer 151, and reduces the roughness of the silver alloy material layer 151M and silver alloy layer 151, but also increases the reflectivity of the silver alloy layer 151 to short-wavelength light, therefore, the addition of indium and antimony may improve the heat resistance and chemical resistance of the silver alloy layer 151, and the addition of antimony may also increase the reflectivity of the silver alloy layer 151 to short-wavelength light. Therefore, by adding indium with a weight percentage greater than or equal to 2% and less than or equal to 8%, and antimony with a weight percentage less than or equal to 3%, the heat resistance, chemical resistance, and reflectivity to short-wavelength light of the silver alloy layer 151 may be effectively improved. This ensures that the reflective surface of the silver alloy material layer 151M may maintain a smaller surface roughness and a better reflectivity after the film formation process of the protective material layer 155M.

On the other hand, in each of the sputtering target used to deposit the silver alloy layer 151, the silver alloy material layer 151M and the silver alloy layer 151 of this embodiment, the total weight percentage of other elements other than silver (i.e., non-silver elements) cannot exceed 10% (i.e., the total weight percentage of other elements other than silver is less than or equal to 10%) to prevent the overall reflectivity of the silver alloy layer 151 from decreasing due to excessive addition of other elements.

In addition, although the indium and antimony elements significantly improve the heat resistance of the silver alloy material layer 151M, they still have a certain tolerability to subsequent processes including halogen elements and sulfur elements. That is, the edge portion of the silver alloy material layer 151M exposed during patterning and after patterning still has the ability to resist subsequent processes and environmental pollution including halogen and sulfur elements, thereby increasing the optical stability and durability of the reflective layer RFL.

Since the silver alloy material layer 151M and the silver alloy layer 151 have excellent chlorine resistance with the addition of palladium, in another embodiment, in addition to indium with a weight percentage greater than or equal to 2% and less than or equal to 8%, or indium with a weight percentage greater than or equal to 2% and less than or equal to 8% and antimony with a weight percentage greater than 0% and less than or equal to 3%, the material of the sputtering target used to deposit the silver alloy layer 151 may also include palladium with a weight percent greater than 0% and less than or equal to 3%, to further improve the ability of the silver alloy material layer 151M or the silver alloy layer 151 to resist subsequent processes and environmental pollution including halogen elements and sulfur elements.

Other embodiments are described below to explain the disclosure in detail, and the same components will be denoted by the same reference numerals, and the description of the same technical content will be omitted. For the description of the omitted part, reference may be made to the above embodiment, and details are not described in the following embodiments.

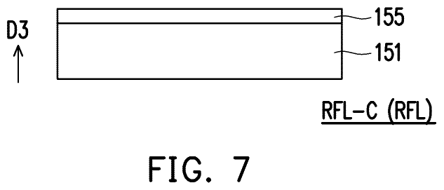

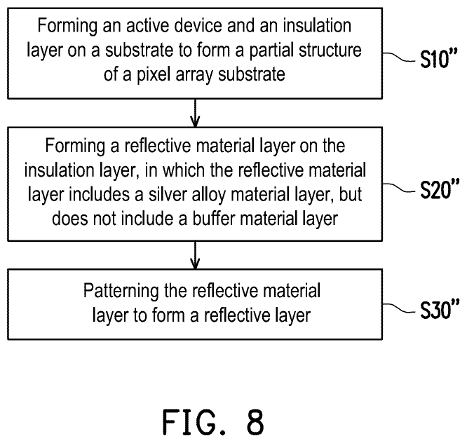

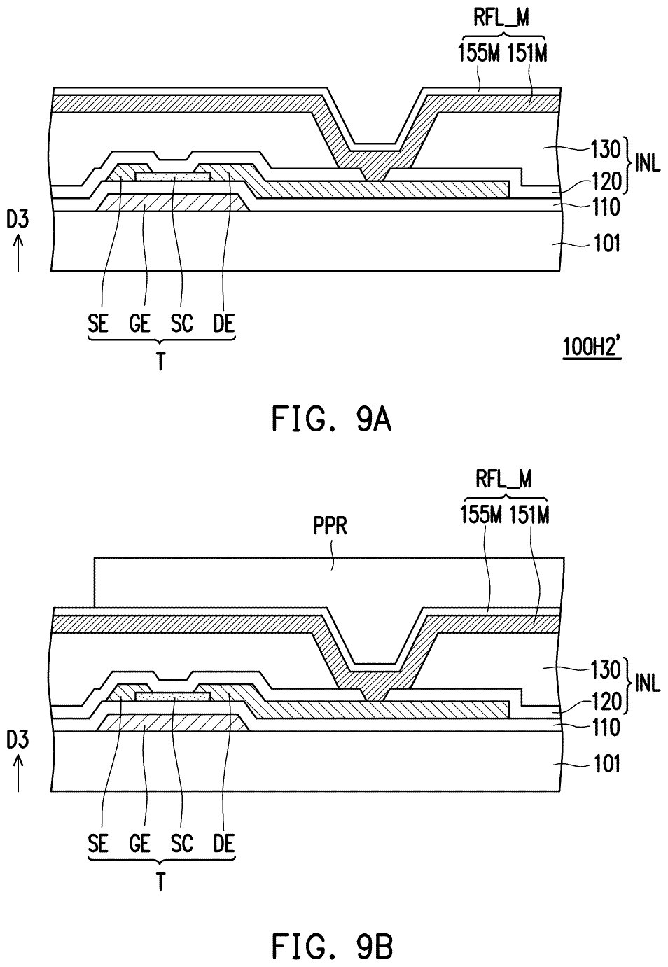

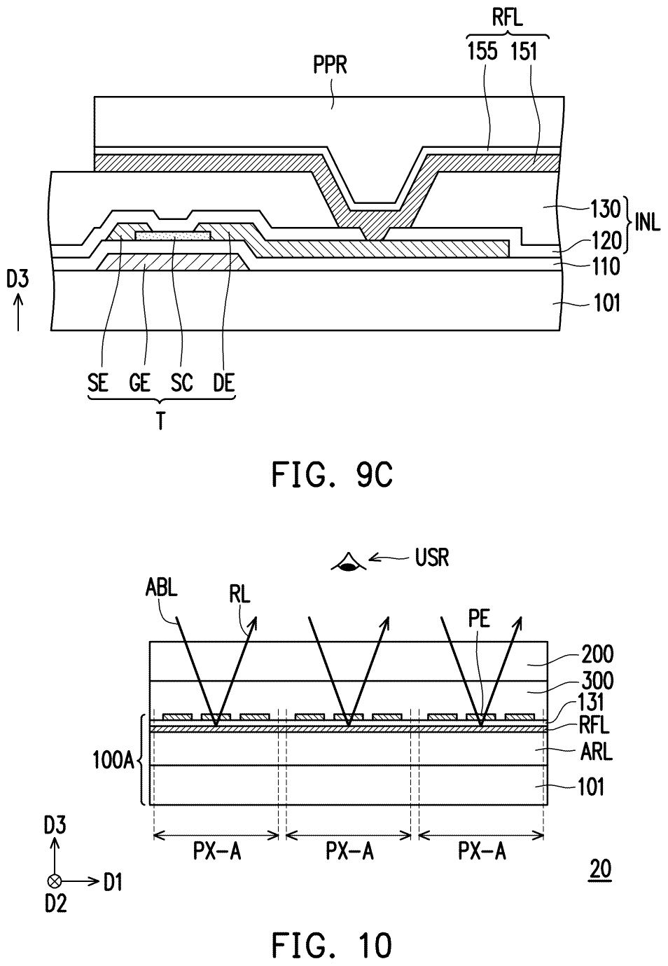

FIG. 7 is an enlarged cross-sectional diagram of the reflective layer of the reflective display panel according to a second embodiment of the disclosure. FIG. 8 is a partial flow chart of a manufacturing method of a reflective display panel having the reflective layer of FIG. 7. FIG. 9A to FIG. 9C are schematic diagrams of the manufacturing method of FIG. 8.

Referring to FIG. 7, the reflective layer RFL of the reflective display panel in this embodiment (e.g., the reflective display panel 10 in FIG. 2) may be the reflective layer RFL-C in FIG. 7. The reflective layer RFL-C in FIG. 7 includes a silver alloy layer 151 and a protective layer 155 but does not include a buffer layer (e.g., it does not include the buffer layer 153 in FIG. 3A or the buffer layers 153a and 153b in FIG. 3B).

Referring to FIG. 8, a part of the manufacturing method of the reflective display panel in this embodiment includes steps S10″ to step S30″. Step S10″ includes forming an active device T and an insulation layer INL on the substrate 101 to form a partial structure 100H1 of the pixel array substrate as shown in FIG. 5A. Next, the reflective layer of the reflective display panel is taken as the reflective layer RFL-C in FIG. 7 to illustrate steps S20″ and S30″. Referring to FIG. 8 and FIG. 9A, step S20″ is performed next. Step S20″ includes forming a reflective material layer RFL_M on the insulation layer INL to form a partial structure 100H2′ of the pixel array substrate. The reflective material layer RFL_M includes a silver alloy material layer 151M and a protective material layer 155M. The silver alloy material layer 151M and the protective material layer 155M are formed by continuous deposition in the same process equipment (such as sputtering equipment). The elemental composition and range of the sputtering target used to deposit the silver alloy material layer 151M, the silver alloy material layer 151M and the silver alloy layer 151 may be the same as the elemental composition and range of the sputtering target used to deposit the silver alloy material layer 151M, the silver alloy material layer 151M and the silver alloy layer 151 of the first embodiment. Referring to FIG. 8, FIG. 9B and FIG. 9C, step S30″ is performed next. Step S30″ includes patterning the reflective material layer RFL_M in the structure of FIG. 9A to form a reflective layer RFL.

It is particularly noted that in this embodiment, although the reflective material layer RFL_M does not have a buffer material layer disposed between the silver alloy material layer 151M and the insulation layer INL, when performing the patterning process of the reflective material layer RFL_M (i.e. step S30′), due to the addition of indium element, or in addition to the indium element, the inclusion of at least one of the antimony and palladium elements, the silver alloy material layer 151M has the ability to resist subsequent processes and environmental pollution including halogen and sulfur elements, thereby maintaining the optical properties of the silver alloy layer 151 and improving the process yield.

For example, in one embodiment, the sputtering target used to deposit the silver alloy layer 151, the silver alloy material layer 151M and the silver alloy layer 151 respectively include silver with a weight percentage greater than 90% and non-silver elements with a weight percentage less than or equal to 10%. The non-silver element composition includes indium with a weight percentage greater than or equal to 2% and less than or equal to 8%.

In another embodiment, the sputtering target used to deposit the silver alloy layer 151, the silver alloy material layer 151M and the silver alloy layer 151 respectively include silver with a weight percentage greater than 90% and non-silver elements with a weight percentage less than or equal to 10%. The non-silver element composition includes indium with a weight percentage greater than or equal to 2% and less than or equal to 8%, and antimony with a weight percentage less than or equal to 3%.

In yet another embodiment, the sputtering target used to deposit the silver alloy layer 151, the silver alloy material layer 151M and the silver alloy layer 151 respectively include silver with a weight percentage greater than 90% and non-silver elements with a weight percentage less than or equal to 10%. The non-silver element composition includes indium with a weight percentage greater than or equal to 2% and less than or equal to 8%, and palladium with a weight percentage less than or equal to 3%.

In yet another embodiment, the sputtering target used to deposit the silver alloy layer 151, the silver alloy material layer 151M and the silver alloy layer 151 respectively include silver with a weight percentage greater than 90% and non-silver elements with a weight percentage less than or equal to 10%. The non-silver element composition includes indium with a weight percentage greater than or equal to 2% and less than or equal to 8%, antimony with a weight percentage less than or equal to 3%, and palladium with a weight percentage less than or equal to 3%.

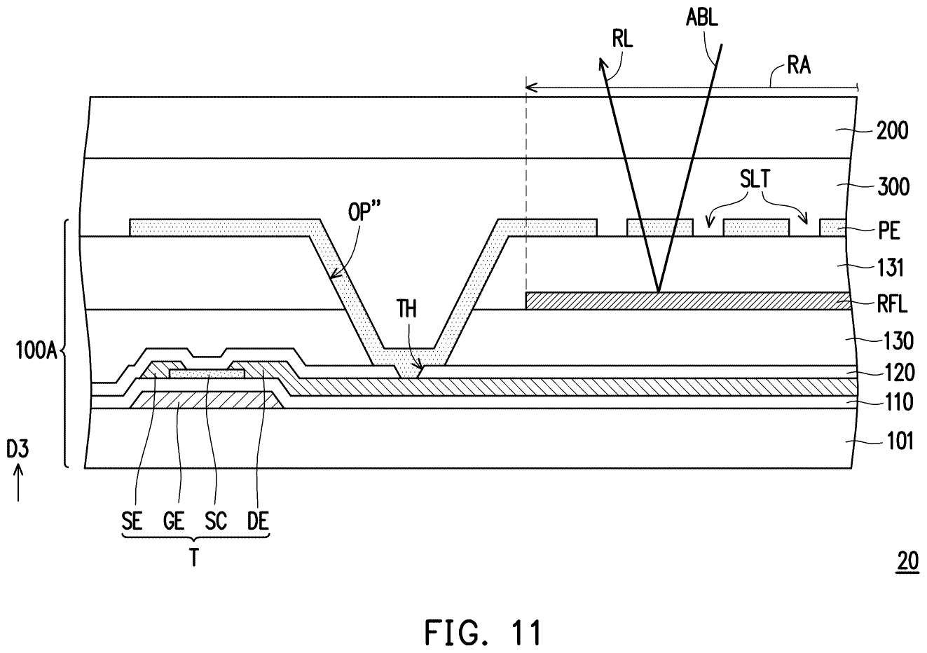

FIG. 10 is a cross-sectional schematic diagram of a reflective display panel according to a third embodiment of the disclosure. FIG. 11 is a cross-sectional schematic diagram of the pixel structure of the reflective display panel according to the third embodiment of the disclosure. Referring to FIG. 10 and FIG. 11, the main difference between the reflective display panel 20 of this embodiment and the reflective display panel 10 of the first and second embodiments is that the pixel electrode PE and the reflective layer RFL of the pixel structure PX-A in this embodiment are different film layers, and the pixel electrode PE and the reflective layer RFL are electrically insulated from each other (i.e., not electrically connected to each other).

Referring to FIG. 10, the reflective display panel 20 includes a pixel array substrate 100A. In this embodiment, the pixel array substrate 100A may include a substrate 101 and multiple pixel structures PX-A. These pixel structures PX-A are arranged in an array (not shown) on the substrate 101. In this embodiment, the pixel electrode PE and the reflective layer RFL of the pixel structure PX-A of the pixel array substrate 100A are different film layers. More specifically, the reflective display panel 30 further includes an insulation layer 131 covering the reflective layer RFL disposed on the planarization layer 130, and the pixel electrode PE is disposed on the insulation layer 131. That is, the pixel electrode PE is disposed on the reflective layer

RFL, and the insulation layer 131 is disposed between the pixel electrode PE and the reflective layer RFL. In addition, in this embodiment, the pixel electrode PE is electrically connected to the drain electrode DE of the active device T through the opening OP″ of the planarization layer 130 and the insulation layer 131 and the contact hole TH of the passivation layer 120. The material of the insulation layer 131 includes, for example, SiO₂, SiNₓ, SiOₓNh_{y} or Al₂O₃.

It is particularly noted that in this embodiment, the pixel electrode PE has multiple micro-slits SLT, and these micro-slits SLT overlap the reflective layer RFL, but not limited thereto. For example, in this embodiment, the pixel electrode PE is, for example, a light-transmissive electrode, and the material of the light-transmissive electrode includes, for example, a metal oxide, such as an indium tin oxide, an indium zinc oxide, an aluminum tin oxide, an aluminum zinc oxide, or other suitable oxides, or a stacked layer of at least two of the foregoing. In this embodiment, the reflective layer RFL may simultaneously serve as a common electrode layer of the pixel structure PX-A, and the common electrode layer may receive a common electric potential or be grounded, but not limited thereto. For example, the reflective layer RFL in FIG. 11 may simultaneously serve as the common electrode layer of the pixel structure PX-A, and the liquid crystal layer (i.e., the display medium layer 300) is driven in a fringe-field switching (FFS) mode. In some embodiments, the reflective layer RFL may be floating, and the common electrode layer (not shown) may be disposed in the pixel array substrate 100A or on the surface of the substrate 200 facing the display medium layer 300.

On the other hand, in this embodiment, the reflective layer RFL is disposed between the planarization layer 130 and the insulation layer 131, and is covered by the insulation layer 131. The reflective layer RFL in this embodiment may be the reflective layer RFL-A in FIG. 3A, the reflective layer RFL-B in FIG. 3B, or the reflective layer RFL-C in FIG. 7. However, the disclosure is not limited thereto. Similar to the first and second embodiments and their modifications, the forming method of the reflective layer RFL in this embodiment may be to form a reflective material layer including a silver alloy material layer (e.g., the silver alloy material layer 151M in the first and second embodiments and their modifications), and then pattern the reflective material layer to form the reflective layer RFL. Reference may be made to the relevant descriptions of the first and second embodiments and their modified embodiments, and the descriptions are not repeated herein. In addition, in some embodiments, the pixel array substrate 100A may also include an alignment layer (not shown), which is disposed on the pixel electrode PE and the insulation layer 131, and the alignment layer is configured to align multiple liquid crystal molecules (not shown) in the liquid crystal layer (i.e., the display medium layer 300). It should be noted that the reflective display panel 20 in this embodiment may be a fully reflective display panel in which the pixel structure has only a reflective area RA, or a transflective display panel in which the pixel structure has a reflective area RA and a transmissive area (not shown).

In this embodiment, there are multiple film layers disposed on the reflective layer RFL, such as the insulation layer 131 and the pixel electrode PE, that is, after the reflective layer RFL is formed, multiple process steps are required to form the pixel array substrate 100A. Therefore, in addition to heat resistance, the silver alloy layer 151 also needs to be resistant to processes including halogen elements and sulfur elements in order to withstand the influence of multiple subsequent process steps.

In order to meet these property requirements, the element compositions and ranges of the sputtering target used to deposit the silver alloy layer 151, the silver alloy material layer and the silver alloy layer 151 in this embodiment may be the same as the elemental compositions and ranges of the sputtering target used to deposit the silver alloy layer 151, the silver alloy material layer 151M and the silver alloy layer 151 of the second embodiment respectively. Specifically, in this embodiment, the material of the sputtering target used to deposit the silver alloy layer 151, the material of the silver alloy material layer, and the material of the silver alloy layer 151 may respectively include silver with a weight percentage greater than 90% and other elements with a weight percentage less than or equal to 10%. The other elements include indium with a weight percentage greater than or equal to 2% and less than or equal to 8%, or include indium with a weight percentage greater than or equal to 2% and less than or equal to 8% and at least one of antimony with a weight percentage less than or equal to 3% and palladium with a weight percentage less than or equal to 3%.

By adding non-silver elements (such as indium, or indium and at least one of antimony and palladium) with a total weight percentage of no more than 10% in the silver alloy material layer and the silver alloy layer 151, the weather resistance and resistance to halogen elements and sulfur elements of the silver alloy material layer 151M and the silver alloy layer 151 may indeed effectively improve, thereby maintaining the optical properties of the silver alloy layer 151 and improving the process yield.

For example, in one embodiment, the non-silver element composition in each of the sputtering target used to deposit the silver alloy layer 151, the silver alloy material layer 151M and the silver alloy layer 151 includes indium with a weight percentage greater than or equal to 2% and less than or equal to 8%.

In another embodiment, the non-silver element composition in each of the sputtering target used to deposit the silver alloy layer 151, the silver alloy material layer 151M and the silver alloy layer 151 includes indium with a weight percentage greater than or equal to 2% and less than or equal to 8%, and antimony with a weight percentage greater than 0% and less than or equal to 3%

In yet another embodiment, the non-silver element composition in each of the sputtering target used to deposit the silver alloy layer 151, the silver alloy material layer 151M and the silver alloy layer 151 includes indium with a weight percentage greater than or equal to 2% and less than or equal to 8%, and palladium with a weight percentage greater than 0% and less than or equal to 3%.

In yet another embodiment, the non-silver element composition in each of the sputtering target used to deposit the silver alloy layer 151, the silver alloy material layer 151M and the silver alloy layer 151 includes indium with a weight percentage greater than or equal to 2% and less than or equal to 8%, antimony with a weight percentage greater than 0% and less than or equal to 3%, and palladium with a weight percentage greater than 0% and less than or equal to 3%.

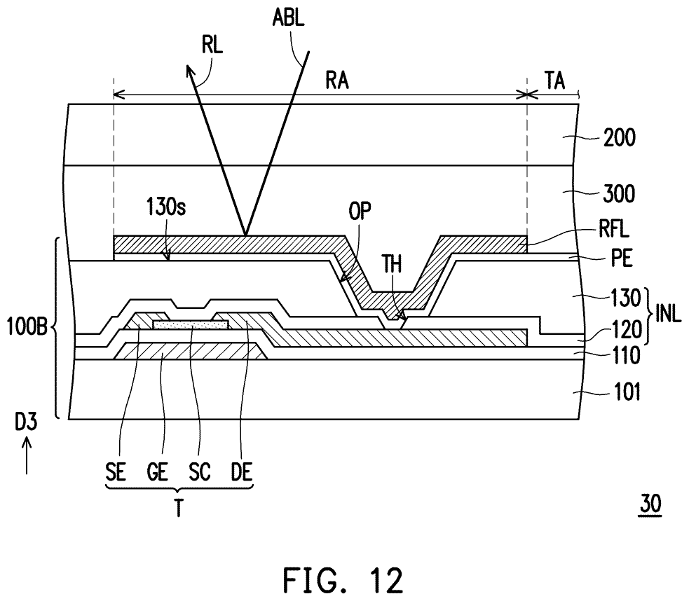

FIG. 12 is a cross-sectional schematic diagram of the pixel structure of the reflective display panel according to a fourth embodiment of the disclosure. Referring to FIG. 12, the difference between the reflective display panel 30 of this embodiment and the reflective display panel 10 of FIG. 1 is that the arrangement of the pixel electrode and the reflective layer is different. For example, in the pixel array substrate 100B of this embodiment, the pixel electrode PE of the pixel structure is, for example, a light-transmissive electrode, and the material of the light-transmissive electrode includes, for example, a metal oxide, such as an indium tin oxide, an indium zinc oxide, an aluminum tin oxide, an aluminum zinc oxide, or other suitable oxides, or a stacked layer of at least two of the foregoing.

That is, in this embodiment, the pixel electrode PE does not simultaneously serve as the reflective layer of the reflective display panel 30, and an additional reflective layer RFL is required to be disposed in the reflective display panel 30. For example, the reflective layer RFL may be disposed on the pixel electrode PE and electrically connected to the pixel electrode PE, but not limited thereto. In other embodiments, the reflective layer RFL may be disposed between the pixel electrode PE and the insulation layer INL.

Specifically, in this embodiment, the reflective layer RFL is located in the reflective area RA of the pixel structure of the reflective display panel 30, and the portion of the pixel electrode PE that is not covered by the reflective layer RFL is located in the light-transmissive area TA of the pixel structure of the reflective display panel 30. That is, the reflective display panel 30 of this embodiment is actually a transflective display panel.

In this embodiment, the reflective layer RFL of the reflective display panel 30 may be the reflective layer RFL-C in FIG. 7, in which the reflective layer RFL-C only includes the silver alloy layer 151 and the protective layer 155. On the other hand, in this embodiment, the pixel electrode PE is disposed between the reflective layer RFL and the insulation layer INL, and the material of the pixel electrode PE is, for example, ITO or IZO. Therefore, the pixel electrode PE may also be used to improve the adhesion between the silver alloy layer 151 and the planarization layer 130. In addition, in some embodiments, the pixel array substrate 100B may also include an alignment layer (not shown), which is disposed on the reflective layer RFL, the pixel electrode PE and the insulation layer INL, and the alignment layer is configured to align multiple liquid crystal molecules (not shown) in the liquid crystal layer (i.e., the display medium layer 300).

The reflective layer RFL of the reflective display panel 30 is the reflective layer RFL-C in FIG. 7, and the silver alloy material layer and the protective material layer that respectively form the silver alloy layer 151 and the protective layer 155 in the reflective layer RFL-C are formed by continuous deposition in the same process equipment (such as sputtering equipment). In this embodiment, the element compositions and ranges of the sputtering target used to deposit the silver alloy layer, the silver alloy material layer and the silver alloy layer 151 may be the same as the elemental compositions and ranges of the sputtering target used to deposit the silver alloy layer 151, the silver alloy material layer 151M and the silver alloy layer 151 of the first embodiment respectively.

To sum up, in the reflective display panel according to an embodiment of the disclosure, for the material of the sputtering target used to deposit the reflective layer, in addition to including silver with a weight percentage of more than 90%, the material also includes indium with a weight percentage greater than or equal to 2% and less than or equal to 8%. Therefore, the chemical resistance and heat resistance of the silver alloy layer deposited using the sputtering target may be significantly improved, thereby increasing the optical stability and durability of the reflective layer. In addition, the above-mentioned silver alloy layer may also have smaller surface roughness, which facilitates in maintaining the high reflectivity of the silver alloy material.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. A reflective display panel, having a pixel structure, wherein the pixel structure has a reflective area and comprises:
an active device;
an insulation layer, disposed above the active device; and
a reflective layer, disposed on the insulation layer and located in the reflective area, wherein the reflective layer comprises a silver alloy layer, a material of the silver alloy layer comprises silver with a weight percentage greater than 90% and indium with a weight percentage greater than or equal to 2% and less than or equal to 8%.

2. The reflective display panel according to claim 1, wherein the material of the silver alloy layer further comprises at least one of antimony and palladium.

3. The reflective display panel according to claim 2, wherein the material of the silver alloy layer further comprises antimony with a weight percentage of less than or equal to 3%.

4. The reflective display panel according to claim 2, wherein the material of the silver alloy layer further comprises palladium with a weight percentage of less than or equal to 3%.

5. The reflective display panel according to claim 1, wherein the reflective layer further comprises:
a protective layer, covering the silver alloy layer, wherein a material of the protective layer comprises a light-transmissive conductive material or a light-transmissive insulation material.

6. The reflective display panel according to claim 5, wherein the material of the protective layer is selected from at least one of an oxide, a nitride, and an oxynitride.

7. The reflective display panel according to claim 5, wherein the silver alloy layer and the protective layer are formed by continuous deposition in the same process equipment.

8. The reflective display panel according to claim 1, wherein the reflective layer further comprises a buffer layer disposed between the insulation layer and the silver alloy layer, and a material of the buffer layer comprises a conductive material.

9. The reflective display panel according to claim 1, wherein a thickness of the silver alloy layer is 70 nanometers to 200 nanometers.

10. The reflective display panel according to claim 1, wherein the reflective display panel is a fully reflective display panel or a transflective display panel.

11. A sputtering target, suitable for depositing the silver alloy layer according to claim 1, wherein a material of the sputtering target comprises silver with a weight percentage greater than 90% and indium with a weight percentage greater than or equal to 2% and less than or equal to 8%.
